(19) United States
(12) Patent Application Publication
(10) Pub. No.: US 2007/0041502 A1
(43) Pub. Date: Feb. 22, 2007

(54) X-ray apparatus and method for operation thereof

(75) Inventor: Eberhard Lenz, Erlangen (DE)

Correspondence Address: SCHIFF HARDIN, LLP;PATENT DEPARTMENT, 6600 SEARS TOWER, CHICAGO, IL, 60606-6473, US

(73) Assignee: Siemens Aktiengesellschaft

(21) Appl. No.: 11/504,416

(22) Filed: Aug. 14, 2006

(30) Foreign Application Priority Data
Aug. 18, 2005 (DE) 10 2005 039 186.9

(51) Int. Cl. H01J 35/00

(52) U.S. Cl. 378/127

(57) ABSTRACT

In an x-ray apparatus and a method for operation thereof, plastic deformations on the surface of the anode are achieved by applied current or the applied voltage being steadily increased up to an operating current strength or an operating voltage within a time segment following initial activation.

### BACKGROUND OF THE INVENTION

1. Field of the Invention

The invention concerns an x-ray apparatus as well as a method for the operation thereof.

2. Description of the Prior Art

X-ray apparatuses are generally known having the basic arrangement of a cathode and an anode mounted opposite the cathode in a vacuum-sealed housing. To generate x-ray radiation, a high voltage is applied between the cathode and the anode and the cathode is heated. An electron beam directed toward the anode forms, causing x-ray radiation and heat to be generated upon the electronics in the beam striking the anode. The surface of the anode deforms (warps) due to the repeated generation of heat with high gradient formation. An appearance known as “orange skin” forms. As a result, if a protective layer is provided on the surface of the anode, it can detach from the anode surface.

The formation of such plastic deformations on the surface and, if applicable, the detachment of a protective layer, lead to a reduced performance yield in the course of time.

### SUMMARY OF THE INVENTION

An object of the invention is to provide a method for operation of an x-ray apparatus as well as an x-ray apparatus with such a performance decrease is reduced in the course of long-term operation of the x-ray apparatus.

This object is achieved according to the invention by controlling an applied current or an applied voltage such that the current strength or the voltage is steadily increased to the operating current strength or the operating voltage from an activation point in time until the expiration of a predetermined time segment.

The “applied current” can be either the current that is applied to accelerate electrons emitted by the cathode to generate an electron beam between the cathode and the anode, or the current that is applied to the cathode for heating thereof. Similarly, the “applied voltage” can be the voltage applied between the cathode and the anode, which accelerates electrons emitted by the cathode toward the anode, or the voltage that is applied to the cathode to heat the cathode. Naturally it is also possible to vary both applied currents or voltages in the sense of the present invention such that a steady heating or cooling of the anode is achieved.

As a result, the formation of thermoshock stresses on the surface of the anode (and, as a result of this, plastic deformations) can be minimized to a significant degree. A protective layer that may be provided on the anode surface does not flake off (spall). The x-ray apparatus can be operated over a long time span with constant performance yield.

As used herein, “steadily” encompasses a continuous as well as a discontinuous increase of the current or of the voltage up to operating current strength or operating voltage. A discontinuous increase, for example, can be a stepped increase. The aforementioned time segment is selected such that the anode is not heated suddenly but rather continuously and the formation of thermoshock stresses is therewith avoided.

In an embodiment of the invention, the aforementioned time segment is a first time segment, and the current or the voltage is controlled such that the operating current strength or, respectively, the operating voltage is steadily decreased to the initial value from a shutdown point in time until the expiration of a second time segment. In particular a fast cooling from high temperature values and a formation of thermoshock stresses associated therewith can be avoided. The formation of unwanted plastic deformations on the surface of the anode can be minimized further.

The first and/or the second time segment is/are advantageously 0.5 to 2 seconds. In practice, neither time segment practically limits the availability of the x-ray apparatus, particularly an x-ray apparatus with a fixed anode. Nonetheless, a distinct improvement of the performance yield of such an x-ray apparatus can be achieved with such relatively short time segments, even over a long time span.

The above object also is achieved in accordance with the invention by an x-ray apparatus having a control unit that controls an applied current or an applied voltage such that the operating current strength or the operating voltage is steadily increased to the operating current strength or the operating voltage from an activation point in time until the expiration of a time segment.

As noted above the “applied current” can be either the current that is applied to accelerate electrons emitted by the cathode to generate an electron beam between the cathode and the anode, or the current that is applied to the cathode for heating thereof. Similarly, the “applied voltage” can be the voltage applied between the cathode and the anode, which accelerates electrons emitted by the cathode toward the anode, or the voltage that is applied to the cathode to heat the cathode. Both currents or voltages can be varied to achieve a steady heating or cooling of the anode. An excellent performance yield can be achieved with the x-ray device, even over a long time span.

The aforementioned control unit can be a conventional device that is modified to cause the current or the voltage of the x-ray tube to be steadily increased to a predetermined operating current strength or a predetermined operating voltage. Naturally a device for regulation (i.e., with feedback) can be used instead of a device for control. The temperature of the anode or the intensity of the x-ray radiation radiated from the anode can be used as a control variable.

According to an advantageous embodiment, the current or the voltage can be controlled with the control unit such that the operating current strength or the operating voltage is steadily lowered to the initial value from a shutdown point in time until the expiration of a second time segment. A “steady” increase or lowering as used herein encompasses a continuous or a discontinuous increase or lowering. A discontinuous increase or lowering, for example, can be a stepped increase or lowering. Since the current or the voltage is not suddenly lowered upon shutdown but rather is steadily lowered according to a predetermined time delay, cooling of the anode can be achieved with prevention of the formation of thermoshock stresses. Plastic deformations on the anode thus can be avoided, and an essentially constant performance yield of the x-ray apparatus thus can be achieved even over a long time span.

The first and/or the second time segment is/are advantageously 0.5 to 2 seconds. In practice the aforementioned time segments have proven to be sufficient to avoid the thermoshock stresses on the surface of the anode.

### DESCRIPTION OF THE DRAWINGS

FIG. 1 is a schematic block diagram of the basic components of an x-ray apparatus operable according to the: invention.

FIG. 2 is an embodiment of a curve of the current for the voltage over time in accordance with the present invention.

### DESCRIPTION OF THE PREFERRED EMBODIMENTS

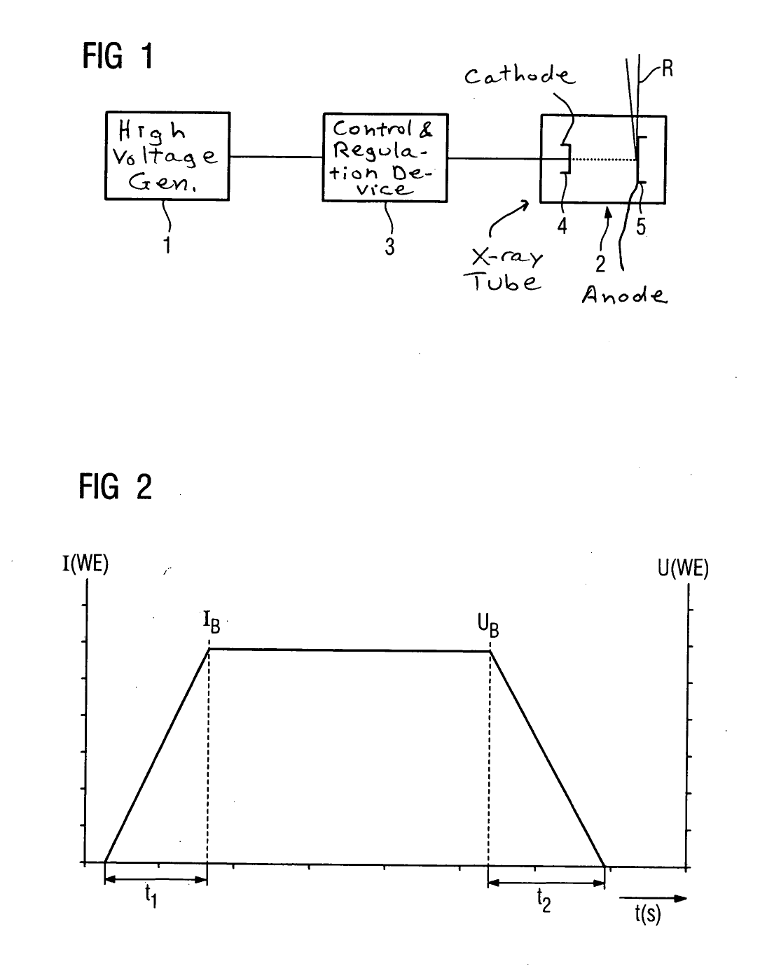

FIG. 1 schematically shows an embodiment of an x-ray apparatus in accordance with the invention. A control and regulation device 3 is connected between a high-voltage generator 1 and an x-ray tube (generally designated with reference numeral 2). The current I or the voltage U supplied from the high-voltage generator 1 is controlled with the control and regulation device 3 such that a current flowing between a cathode 4 and an anode 5 steadily increases to an operating current strength I_{B} or an operating voltage U_{B} within a first time segment t₁. In the reverse manner, upon shutdown it is also possible with the device 3 to steadily lower the operating current strength I_{B} or, respectively, an operating voltage U_{B} to an initial value (for example 0) within a second time segment t₂ following the deactivation point in time.

In a manner similar to that shown in FIG. 1, a cathode heating also can be provided with a control and regulation device so that the heating current of the cathode 4 can be correspondingly regulated. A desired heating or cooling profile of the anode 5 thus can also be achieved.

FIG. 2 shows an example of a curve of the current I or of the voltage U in arbitrary units. Upon activation the current I or the voltage U is increased continuously to a predetermined operating current strength I_{B} or a predetermined operating voltage U_{B} within a first time span t₁, from the activation point in time. The operating current strength I_{B} or, respectively, operating voltage U_{B} subsequently remains constant up to a shutdown point in time. Within a second time span t₂ which begins as of the shutdown point in time, the current I or the voltage U is continuously lowered to the initial value (for example 0). As a result of the steady increase or decrease of the current I charging the anode 5, the temperature of the anode rises or falls to such a degree that thermoshock stresses are avoided. As a result, plastic deformation caused on the surface of the anode 5 by thermoshock stresses is avoided. Formation of an “orange skin”, which causes a radiation of the formed x-ray radiation R in unwanted directions and therewith a decrease in the performance of the x-ray apparatus, does not occur.

The steady increase or decrease of the current I or voltage U charging the anode shown in FIG. 1 can ensue not only linearly but also in a stepped manner. It is only important that, differing from the prior art, the anode is not immediately charged at the activation point in time with the operating current strength I_{B} or the operating voltage U_{B}, but rather that the current I or, respectively, the voltage U is increased to the operating values within predetermined time spans so that the formation of thermoshock stresses on the surface of the anode does not occur.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for operating an x-ray apparatus having a cathode and an anode, said method comprising the steps of:
beginning at an activation point in time, applying an applied current between said anode and said cathode starting at a predetermined initial current strength, that is less than an operating current strength, and controlling said applied current to steadily increase said applied current from said initial current strength to said operating current strength until expiration of a predetermined time segment; and
thereafter operating said x-ray apparatus at said operating current strength.

2. A method as claimed in claim 1 wherein said time segment is a first time segment, and comprising, starting at a shutdown point in time of said x-ray apparatus, controlling said applied current to decrease said applied current from said operating current strength to said initial value until expiration of a predetermined second time segment.

3. A method as claimed in claim 2 wherein each of said first time segment and said second time segment is in a range between 0.5 and 2 seconds.

4. A method as claimed in claim 1 wherein said time segment is in a range between 0.5 and 2 seconds.

5. A method for operating an x-ray apparatus having a cathode and an anode, comprising the steps of:
beginning at an activation point in time of said x-ray apparatus, applying an applied current at an initial current strength to said cathode to cause said cathode to emit electrons, and controlling said applied current to steadily increase said applied current from said initial current strength to an operating current strength until expiration of a predetermined time segment; and
thereafter operating said x-ray apparatus at said operating current strength.

6. A method as claimed in claim 5 wherein said time segment is a first time segment, and comprising, starting at a shutdown point in time of said x-ray apparatus, controlling said applied current to decrease said applied current from said operating current strength to said initial value until expiration of a predetermined second time segment.

7. A method as claimed in claim 6 wherein each of said first time segment and said second time segment is in a range between 0.5 and 2 seconds.

8. A method as claimed in claim 5 wherein said time segment is in a range between 0.5 and 2 seconds.

9. A method for operating an x-ray apparatus having a cathode and an anode, said method comprising the steps of:
beginning at an activation point in time, applying an applied voltage between said anode and said cathode starting at a predetermined initial voltage, that is less than an operating voltage, and controlling said applied voltage to steadily increase said applied voltage from said initial voltage to said operating voltage until expiration of a predetermined time segment; and
thereafter operating said x-ray apparatus at said operating voltage.

10. A method as claimed in claim 9 wherein said time segment is a first time segment, and comprising, starting at a shutdown point in time of said x-ray apparatus, controlling said applied voltage to decrease said applied voltage from said operating voltage to said initial value until expiration of a predetermined second time segment.

11. A method as claimed in claim 10 wherein each of said first time segment and said second time segment is in a range between 0.5 and 2 seconds.

12. A method as claimed in claim 9 wherein said time segment is in a range between 0.5 and 2 seconds.

13. A method for operating an x-ray apparatus having a cathode and an anode, comprising the steps of:
beginning at an activation point in time of said x-ray apparatus, applying an applied voltage at an initial voltage to said cathode to cause said cathode to emit electrons, and controlling said applied voltage to steadily increase said applied voltage from said initial voltage to an operating voltage until expiration of a predetermined time segment; and
thereafter operating said x-ray apparatus at said operating voltage.

14. A method as claimed in claim 13 wherein said time segment is a first time segment, and comprising, starting at a shutdown point in time of said x-ray apparatus, controlling said applied voltage to decrease said applied voltage from said operating voltage to said initial value until expiration of a predetermined second time segment.

15. A method as claimed in claim 14 wherein each of said first time segment and said second time segment is in a range between 0.5 and 2 seconds.

16. A method as claimed in claim 13 wherein said time segment is in a range between 0.5 and 2 seconds.

17. An x-ray apparatus comprising the steps of:
an anode;
a cathode;
a control unit that, beginning at an activation point in time, applies an applied current between said anode and said cathode starting at a predetermined initial current strength, that is less than an operating current strength, and controls said applied current to steadily increase said applied current from said initial current strength to said operating current strength until expiration of a predetermined time segment, and thereafter operates said x-ray apparatus at said operating current strength.

18. An x-ray apparatus as claimed in claim 17 wherein said time segment is a first time segment, and wherein said control unit, starting at a shutdown point in time of said x-ray apparatus, controls said applied current to decrease said applied current from said operating current strength to said initial value until expiration of a predetermined second time segment.

19. An x-ray apparatus as claimed in claim 18 wherein each of said first time segment and said second time segment is in a range between 0.5 and 2 seconds.

20. An x-ray apparatus as claimed in claim 17 wherein said time segment is in a range between 0.5 and 2 seconds.

21. An x-ray apparatus for operating an x-ray apparatus comprising:
an anode;
a cathode;
a control unit that, beginning at an activation point in time of said x-ray apparatus, applies an applied current at an initial current strength to said cathode to cause said cathode to emit electrons, and controls said applied current to steadily increase said applied current from said initial current strength to an operating current strength until expiration of a predetermined time segment; and thereafter operates said x-ray apparatus at said operating current strength.

22. An x-ray apparatus as claimed in claim 21 wherein said time segment is a first time segment, and wherein said control unit, starting at a shutdown point in time of said x-ray apparatus, controls said applied current to decrease said applied current from said operating current strength to said initial value until expiration of a predetermined second time segment.

23. An x-ray apparatus as claimed in claim 22 wherein each of said first time segment and said second time segment is in a range between 0.5 and 2 seconds.

24. An x-ray apparatus as claimed in claim 22 wherein said time segment is in a range between 0.5 and 2 seconds.

25. An x-ray apparatus comprising:
an anode;
a cathode;
a control unit that, beginning at an activation point in time, applies an applied voltage between said anode and said cathode starting at a predetermined initial voltage, that is less than an operating voltage, and controls said applied voltage to steadily increase said applied voltage from said initial voltage to said operating voltage until expiration of a predetermined time segment, and thereafter operates said x-ray apparatus at said operating voltage.

26. An x-ray apparatus as claimed in claim 25 wherein said time segment is a first time segment, and wherein said control unit, starting at a shutdown point in time of said x-ray apparatus, controls said applied voltage to decrease said applied voltage from said operating voltage to said initial value until expiration of a predetermined second time segment.

27. An x-ray apparatus as claimed in claim 26 wherein each of said first time segment and said second time segment is in a range between 0.5 and 2 seconds.

28. An x-ray apparatus as claimed in claim 26 wherein said time segment is in a range between 0.5 and 2 seconds.

29. An x-ray apparatus for comprising:
an anode;
a cathode;
a control unit that, beginning at an activation point in time of said x-ray apparatus, applies an applied voltage at an initial voltage to said cathode to cause said cathode to emit electrons, and controls said applied voltage to steadily increase said applied voltage from said initial voltage to an operating voltage until expiration of a predetermined time segment; and
thereafter operating said x-ray apparatus at said operating voltage.

30. An x-ray apparatus as claimed in claim 29 wherein said time segment is a first time segment, and comprising, starting at a shutdown point in time of said x-ray apparatus, controlling said applied voltage to decrease said applied voltage from said operating voltage to said initial value until expiration of a predetermined second time segment.

31. An x-ray apparatus as claimed in claim 30 wherein each of said first time segment and said second time segment is in a range between 0.5 and 2 seconds.

32. An x-ray apparatus as claimed in claim 31 wherein said time segment is in a range between 0.5 and 2 seconds.
